(19) United States
(12) Patent Application Publication
(10) Pub. No.: US 2026/0019294 A1
(43) Pub. Date: Jan. 15, 2026

(54) RELAY DEVICE, MONITORING DEVICE, RELAY PROGRAM, AND MONITORING PROGRAM

(71) Applicants: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(72) Inventors: Yojiro SUYAMA, Osaka-shi (JP); Tatsuya IZUMI, Osaka-shi (JP); Hideyuki TANAKA, Osaka-shi (JP); Yusuke YAMAMOTO, Osaka-shi (JP); Yoshio ITO, Osaka-shi (JP); Ryo YAMANE, Osaka-shi (JP); Kenta OGATA, Osaka-shi (JP); Makoto CHUJO, Osaka-shi (JP); Yoshitaka KIKUCHI, Yokkaichi-shi (JP); Darmawan GO, Yokkaichi-shi (JP); Hirofumi URAYAMA, Yokkaichi-shi (JP); Hideki GOTO, Toyota-shi (JP); Yasuhiro YAMASAKI, Toyota-shi (JP); Ikuyoshi OTAKE, Toyota-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP); TOYOTA JIDOSHA KABUSHIKI KAISHA, Toyota-shi, Aichi (JP)

(21) Appl. No.: 18/993,821

(22) PCT Filed: May 22, 2023
(86) PCT No.: PCT/JP2023/018854

§ 371 Date: Jan. 13, 2025

(30) Foreign Application Priority Data
Jul. 29, 2022 (JP) 2022-121046

(51) Int. Cl. H04L 12/40; H04L 9/40; H04L 41/0816

(52) U.S. Cl. CPC H04L 12/40; H04L 41/0816; H04L 63/08; H04L 2012/40273

(57) ABSTRACT

A relay device for use in an in-vehicle network that includes a plurality of functional units, the relay device includes: a relay unit configured to perform relay processing for relaying frames transmitted and received between the functional units; a detection unit configured to detect addition of a functional unit to the in-vehicle network; and a control unit configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed.

### TECHNICAL FIELD

The present disclosure relates to a relay device, a monitoring device, a relay program, and a monitoring program.

This application is based upon and claims the benefit of priority from Japanese patent application No. 2022-121046 filed on Jul. 29, 2022 the disclosure of which is incorporated herein in their entirety by reference.

### BACKGROUND ART

Patent Document 1 (WO 2020/145334) discloses the following technology. A vehicle control device controls a plurality of relays constituting a vehicle network constructed within a vehicle, based on a control scenario in which a state of the vehicle is associated with a control content set for each of the plurality of relays.

### CITATION LIST

### Patent Document

Patent Document 1: WO 2020/145334

### SUMMARY OF THE INVENTION

A relay device according to the present disclosure is a relay device for use in an in-vehicle network that includes a plurality of functional units, including: a relay unit configured to perform relay processing for relaying frames transmitted and received between the functional units; a detection unit configured to detect addition of a functional unit to the in-vehicle network; and a control unit configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed.

One aspect of the present disclosure can be realized not only as a relay device that includes such characteristic processing units, but also as a relay method for carrying out such characteristic processing as steps. Also, one aspect of the present disclosure can be realized as a semiconductor integrated circuit that realizes a part or the entirety of the relay device, or a system that includes the relay device.

One aspect of the present disclosure can be realized not only as a monitoring device that includes such characteristic processing units, but also as a monitoring method for carrying out such characteristic processing as steps. Also, one aspect of the present disclosure can be realized as a semiconductor integrated circuit that realizes a part or the entirety of the monitoring device, or a system that includes the monitoring device.

### BRIEF DESCRIPTION OF THE DRAWINGS

FIG. 1 is a diagram showing the configuration of an in-vehicle communication system according to an embodiment of the present disclosure.

FIG. 2 is a diagram showing the configuration of a relay device according to the embodiment of the present disclosure.

FIG. 3 is a diagram showing the configuration of an in-vehicle communication system according to the embodiment of the present disclosure.

FIG. 4 is a diagram showing the configuration of a relay device according to the embodiment of the present disclosure.

FIG. 5 shows an example of setting statuses of the relay devices in the in-vehicle communication system according to the embodiment of the present disclosure.

FIG. 6 is a diagram showing an example of the sequence of processing for constructing a new network that is performed in the in-vehicle communication system according to the embodiment of the present disclosure.

FIG. 7 is a diagram showing another example of the sequence of processing for constructing a new network that is performed in the in-vehicle communication system according to the embodiment of the present disclosure.

### DESCRIPTION OF EMBODIMENTS

Technology for changing configuration settings for an in-vehicle network has been developed.

### Problem to be Solved by the Present Disclosure

When settings for an in-vehicle network are dynamically changed, such setting changes may affect communication in the in-vehicle network.

The present disclosure has been made to solve the problem above, and an object thereof is to provide a relay device, a monitoring device, a relay program, and a monitoring program that make it possible to construct an in-vehicle network with a new configuration while maintaining stable operation of the in-vehicle network.

### Effects of the Present Disclosure

With the present disclosure, it is possible to construct an in-vehicle network with a new configuration while maintaining stable operation of the in-vehicle network.

### Description of Embodiment of Present Disclosure

First, the details of an embodiment of the present disclosure are listed and described.
(1) A relay device according to an embodiment of the present disclosure is a relay device for use in an in-vehicle network that includes a plurality of functional units, including: a relay unit configured to perform relay processing for relaying frames transmitted and received between the functional units; a detection unit configured to detect addition of a functional unit to the in-vehicle network; and a control unit configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed.

With this configuration, in which the relay processing of frames transmitted from a new functional unit is restricted in a state where setting changes for a new network have not yet been completed, it is possible to prevent frames transmitted from the new functional unit in this state from affecting existing communication between the functional units in the in-vehicle network, such as by increasing the amount of traffic and decreasing transmission quality in the in-vehicle network. Accordingly, it is possible to construct an in-vehicle network with a new configuration while maintaining stable operation of the in-vehicle network.
(2) In the above (1), a configuration is possible in which, the in-vehicle network includes, in addition to a first relay device, which is the relay device, one or more second relay devices, which are relay devices configured to relay frames transmitted and received between the functional units, and the control unit is configured to relax the restriction on the relay processing when the setting processing of all the relay devices in the in-vehicle network is completed.

With this configuration, in an in-vehicle network that includes a plurality of relay devices, the difference in the timing of completion of the setting processing between the relay devices can be prevented from affecting existing communication between the functional units.
(3) In the above (2), a configuration is possible in which, the first relay device further includes: a setting unit configured to issue a predetermined notification to the other devices in the in-vehicle network when the setting processing of the first relay device is completed.

With this configuration, in an in-vehicle network that includes a plurality of relay devices, completion of the setting processing of the plurality of relay devices can be easily acknowledged by the other devices.
(4) In any of the above (1) to (3), a configuration is possible in which,

authentication processing for the new functional unit is performed prior to the setting processing, and the control unit is configured to restrict the relay processing of frames 20 transmitted from the new functional unit except for a frame used for the authentication processing for the new functional unit and to restrict the relay processing of frames transmitted from the new functional unit except for a frame used for the setting processing when the authentication processing is completed.

With this configuration, the content of the restriction on the relay processing can be appropriately set according to the progress statuses of the authentication processing for the new functional unit and the setting processing for the in-vehicle network.
(5) A monitoring device according to an embodiment of the present disclosure is a monitoring device for use in an in-vehicle network that includes a plurality of functional units and a plurality of relay devices configured to relay frames transmitted and received between the functional units, including: an update confirmation unit configured to confirm completion of setting processing of the plurality of relay devices, the setting processing being for enabling communication in a new network, which is the in-vehicle network in which a new functional unit is connected to any of the relay devices; and a notification unit configured to, if the update confirmation unit confirms the completion, notifies the relay device to which the new functional unit is connected of the completion.

With this configuration, the relay device to which the new functional unit is connected can restrict the relay processing of frames transmitted from the new functional unit in a state where setting changes for the new network have not yet been completed in the relay devices. Thus, it is possible to prevent frames transmitted from the new functional unit in this state from affecting existing communication between the functional units in the in-vehicle network, such as by increasing the amount of traffic and decreasing transmission quality in the in-vehicle network. Accordingly, it is possible to construct an in-vehicle network with a new configuration while maintaining stable operation of the in-vehicle network.
(6) In the above (5), a configuration is possible in which, the relay device further includes a generation unit configured to create a setting content for enabling communication in the new network and notify one or more of the relay devices of the setting content.

With this configuration, centralized management of the setting processing for a new network and the confirmation of completion of the setting processing in the relay devices is possible, and a more efficient in-vehicle network can thus be realized.
(7) A relay program according to an embodiment of the present disclosure is a relay program for a relay device for use in an in-vehicle network that includes a plurality of functional units, the relay program causing a computer to function as: a relay unit configured to perform relay processing for relaying frames transmitted and received between the functional units; a detection unit configured to detect addition of a functional unit to the in-vehicle network; and a control unit configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed.

With this configuration, in which the relay processing of frames transmitted from a new functional unit is restricted in a state where setting changes for a new network have not yet been completed, it is possible to prevent frames transmitted from the new functional unit in this state from affecting existing communication between the functional units in the in-vehicle network, such as by increasing the amount of traffic and decreasing transmission quality in the in-vehicle network. Accordingly, it is possible to construct an in-vehicle network with a new configuration while maintaining stable operation of the in-vehicle network.
(8) A monitoring program according to an embodiment of the present disclosure is a monitoring program for a monitoring device for use in an in-vehicle network that includes a plurality of functional units and a plurality of relay devices configured to relay frames transmitted and received between the functional units, the monitoring program causing a computer to function as: an update confirmation unit configured to confirm completion of setting processing of the plurality of relay devices, the setting processing being for enabling communication in a new network, which is the in-vehicle network in which a new functional unit is connected to any of the relay devices; and a notification unit configured to, if the update confirmation unit confirms the completion, notify the relay device to which the new functional unit is connected of the completion.

With this configuration, in which the relay processing of frames transmitted from a new functional unit is restricted in a state where setting changes for a new network have not yet been completed, it is possible to prevent frames transmitted from the new functional unit in this state from affecting existing communication between the functional units in the in-vehicle network, such as by increasing the amount of traffic and decreasing transmission quality in the in-vehicle network. Accordingly, it is possible to construct an in-vehicle network with a new configuration while maintaining stable operation of the in-vehicle network.

Hereinafter, embodiments of the present disclosure will be described with reference to the drawings. Note that, in the drawings, the same reference numerals are given to the same or corresponding components in the drawings, and redundant descriptions thereof are not repeated. Furthermore, at least parts of the embodiments described below may be suitably combined.

### In-Vehicle Communication System

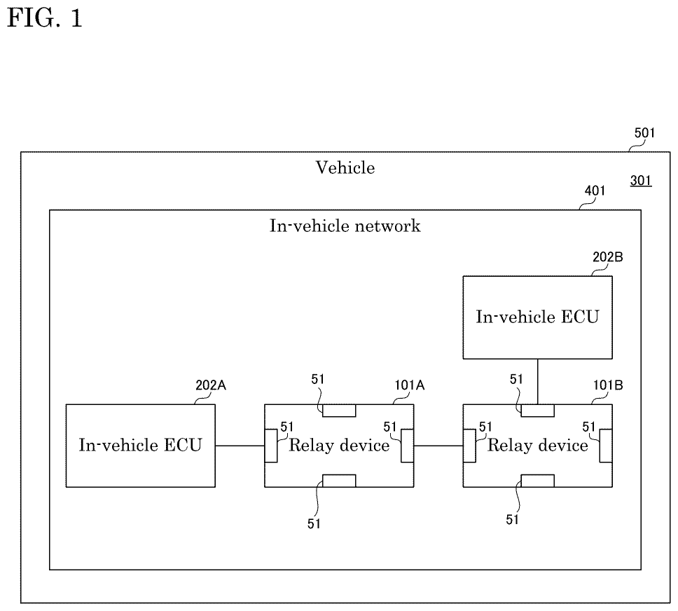

FIG. 1 is a diagram showing the configuration of an in-vehicle communication system according to an embodiment of the present disclosure. Referring to FIG. 1, an in-vehicle communication system 301 includes one or more in-vehicle electronic control units (ECUs) 202 and one or more relay devices 101.

In an example shown in FIG. 1, the in-vehicle communication system 301 includes in-vehicle ECUs 202A and 202B, which are in-vehicle ECUs 202, as well as relay devices 101A and 101B, which are relay devices 101. The in-vehicle communication system 301 is installed in a vehicle 501. The in-vehicle ECUs 202 and the relay devices 101 constitute an in-vehicle network 401. The in-vehicle ECUs 202 are examples of a functional unit. The relay device 101A is an example of a monitoring device.

The in-vehicle communication system 301 is not limited to a configuration with two in-vehicle ECUs 202, and may be configured to include one or three or more in-vehicle ECUs 202. Also, the in-vehicle communication system 301 is not limited to a configuration with two relay devices 101, and may be configured to include one or three or more relay devices 101.

In the in-vehicle network 401, the in-vehicle ECUs 202 are connected to the relay devices 101 via, for example, Ethernet (registered trademark) cables.

More specifically, the relay devices 101 each include a plurality of communication ports 51. The communication ports 51 are terminals to which Ethernet cables, for example, can be connected. Each relay device 101 and each in-vehicle ECU 202 is connected to another relay device 101 or in-vehicle ECU 202 via a communication port 51 and an Ethernet cable.

The relay devices 101 are used in the in-vehicle network 401 that includes the plurality of in-vehicle ECUs 202. Each relay device 101 may be, for example, a gateway device, and can relay data between a plurality of in-vehicle ECUs 202 connected to that relay device 101. The relay devices 101 can perform relay processing according to, for example, Layer 2, and Layer 3, which is at a higher level than Layer 2.

More specifically, the relay devices 101 perform relay processing of frames exchanged between in-vehicle ECUs 202 connected thereto via Ethernet cables according to Ethernet communication standards, for example.

Note that the in-vehicle communication system 301 is not limited to a configuration in which frames are relayed according to Ethernet communication standards, and may have a configuration in which frames are relayed according to a communication standard such as Controller Area Network (CAN), CAN with Flexible Data Rate (CAN FD), FlexRay (registered trademark), Media Oriented Systems Transport (MOST) (registered trademark), or Local Interconnect Network (LIN).

Each in-vehicle ECU 202 may be, for example, an automatic driving ECU, an engine ECU, a sensor, a navigating device, a human-machine interface, a camera, or the like.

Each relay device 101 and each in-vehicle ECU 202 generates frames containing various kinds of information, which will be described later, and transmits the frames to another in-vehicle ECU 202 or relay device 101.

### Relay Device 101B

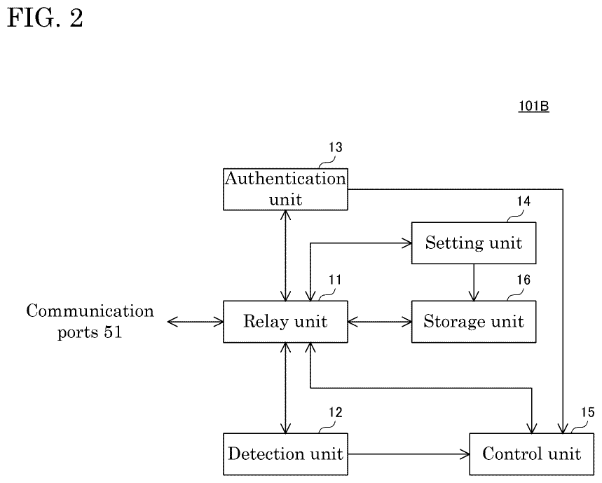

FIG. 2 is a diagram showing the configuration of a relay device according to the embodiment of the present disclosure. FIG. 2 shows the configuration of the relay device 101B shown in FIG. 1.

Referring to FIG. 2, the relay device 101B includes a relay unit 11, a detection unit 12, an authentication unit 13, a setting unit 14, a control unit 15, and a storage unit 16. The storage unit 16 may be a nonvolatile memory, for example.

The relay unit 11 performs relay processing for relaying frames transmitted and received between the in-vehicle ECUs 202. More specifically, upon receiving a frame from a certain in-vehicle ECU 202 or the relay device 101A, the relay unit 11 transmits the received frame to another in-vehicle ECU 202 that is the transmission destination or to another relay device 101A.

Also, upon receiving a frame addressed to its own relay device 101 from a new functional unit newly added to the in-vehicle network 401, the relay unit 11 outputs the received frame to the detection unit 12 or the authentication unit 13.

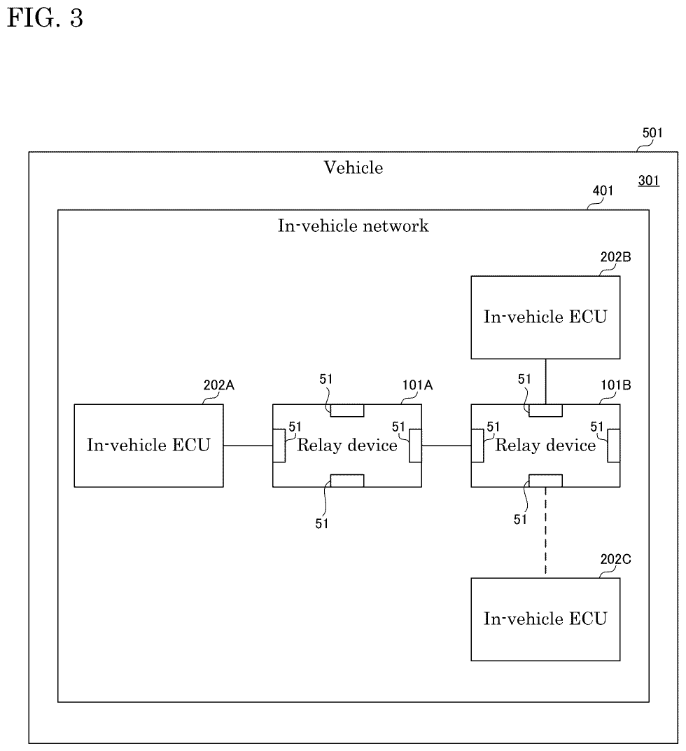

FIG. 3 is a diagram showing the configuration of an in-vehicle communication system according to the embodiment of the present disclosure. FIG. 3 shows the configuration of the in-vehicle network 401, where an in-vehicle ECU 202C is newly added to the in-vehicle network 401 shown in FIG. 1.

Referring to FIG. 3, the in-vehicle ECU 202C is connected to a communication port 51 of the relay device 101B via an Ethernet cable, for example.

The detection unit 12 detects the addition of a functional unit to the in-vehicle network 401. That is, the detection unit 12 detects a new functional unit, which is the in-vehicle ECU 202C here, as a functional unit to be newly added to the in-vehicle network 401.

Once the in-vehicle ECU 202C is connected to the communication port 51 of the relay device 101B and receives power supply, the in-vehicle ECU 202C transmits, to the relay device 101B, a frame containing connection request information to request communication connection in the in-vehicle network 401.

The detection unit 12 receives the frame containing the connection request information via the relay unit 11, thereby detecting the in-vehicle ECU 202C, which is the new functional unit that transmitted the connection request information, and then transmits a frame containing a connection request response to the in-vehicle ECU 202C via the relay unit 11. The detection unit 12 also issues a notification indicating that the detection unit 12 has detected the new functional unit to the control unit 15.

Note that the detection unit 12 may also be configured to periodically, for example, broadcast a search message for detecting a new functional unit via the relay unit 11. In this case, a new functional unit receives the search message and transmits the connection request information as a response to the received search message.

The detection unit 12 may also be configured to detect an application installed in an existing in-vehicle ECU 202 in the in-vehicle network 401 as a new functional unit. That is to say, the new functional unit may be hardware or software.

Hereinafter, the in-vehicle network 401 including a new functional unit may also be referred to as a new network, the in-vehicle network 401 before the addition of the new functional unit may also be referred to as an existing network, and a functional unit included in the existing network may also be referred to as an existing functional unit.

In the in-vehicle communication system 301, for example, authentication processing for a new functional unit is performed prior to network setting processing, which will be described later.

More specifically, the in-vehicle ECU 202C receives the connection request response from the relay device 101B and then transmits a frame containing its own ID and an authentication password to the relay device 101B.

The authentication unit 13 of the relay device 101B receives the frame transmitted from the in-vehicle ECU 202C via the relay unit 11 and performs authentication processing for the in-vehicle ECU 202C using the ID and the authentication password contained in the received frame.

If the in-vehicle ECU 202C is successfully authenticated, the authentication unit 13 transmits a frame containing authentication success information indicating that in-vehicle ECU 202C has been successfully authenticated to the in-vehicle ECU 202C via the relay unit 11.

If a new functional unit is successfully authenticated as described above, the authentication unit 13 transmits a frame containing device connection information indicating, for example, the ID of the new functional unit to the relay device 101A via the relay unit 11.

Note that the in-vehicle ECU 202C may be configured to transmit the frame containing the connection request information to the relay device 101B with its own ID and the authentication password additionally included therein.

### Relay Device 101A

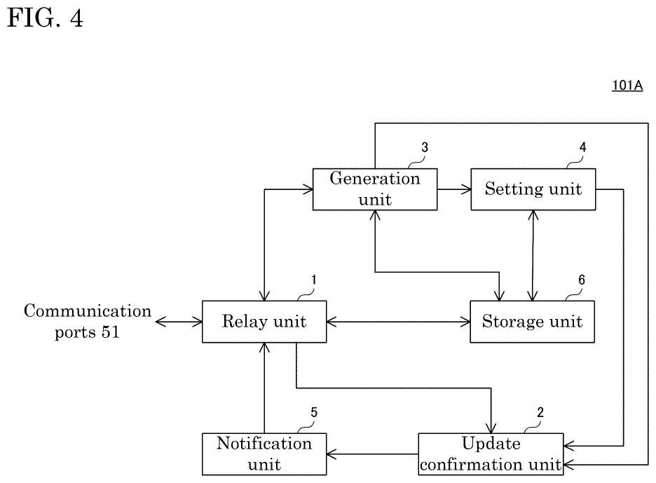

FIG. 4 is a diagram showing the configuration of a relay device according to the embodiment of the present disclosure. FIG. 4 shows the configuration of the relay device 101A shown in FIG. 1.

Referring to FIG. 4, the relay device 101A includes a relay unit 1, an update confirmation unit 2, a generation unit 3, a setting unit 4, a notification unit 5, and a storage unit 6. The storage unit 6 may be a flash memory, for example.

The relay unit 1 performs relay processing for relaying frames transmitted and received between the in-vehicle ECUs 202. More specifically, upon receiving a frame from a certain in-vehicle ECU 202 or the relay device 101B, the relay unit 1 transmits the received frame to another in-vehicle ECU 202 that is the transmission destination or to another relay device 101B.

The generation unit 3 acquires device information including information regarding the network configuration of a layer at a lower level than the application layer, for example, of each of a new functional unit, existing functional units, and the relay devices 101A and 101B.

More specifically, upon receiving device connection information from the relay device 101B via the relay unit 1, the generation unit 3 acquires device information of a new functional unit indicated by the device connection information and also acquires device information of the existing functional units and the relay devices 101A and 101B.

For example, the generation unit 3 acquires, as the device information, information based on which specifications of hardware devices, such as the in-vehicle ECUs 202 and the relay devices 101, in a new network and the topology of the new network can be recognized, as well as information based on which at least one of the following can be recognized: constraints regarding the placement of an application to a hardware device in the new network and constraints imposed by the communication method on the new network.

As the information based on which specifications of hardware devices and the topology of the new network can be recognized, the generation unit 3 acquires, for example, at least one of the following types of information: information regarding identifiers of the hardware devices, their names, their device types indicating the sensor type or the like, their memory sizes, the numbers of physical ports provided for each communication protocol, identifiers of the physical ports, power supply configurations, power consumptions, Virtual Local Area Network (VLAN) IDs, subnet addresses, and functional domains; information regarding specifications of CPUs or Graphics Processing Units (GPUs) installed in the hardware devices; information regarding the connection relationship between the hardware devices; information regarding the bandwidth of communication between the hardware devices; and information regarding the specifications of the relay devices 101.

As the information based on which constraints regarding the placement of an application to a hardware device can be recognized, the generation unit 3 acquires, for example, at least one of the following types of information: information regarding the computing speed that is needed to execute an application on an in-vehicle ECU 202, the application's memory usage, constraints imposed by the operating system (OS) environment, and constraints imposed by the communication protocols such as Transmission Control Protocol (TCP) and User Datagram Protocol (UDP).

As the information based on which constraints imposed by the communication method on the new network can be recognized, the generation unit 3 acquires at least one of the following types of information: information regarding the size of communication data, the frequency of communication, whether burst transmission is required, the acceptable delay time, the acceptable amount of loss, the level of security required, the timing of operation, the communication type indicating, for example, whether the communication is periodic or irregular, the identifier of an application serving as a communication partner, the messaging method indicating whether it is a request-response type, a publish-subscribe type, or another type for an application on an in-vehicle ECU 202, and the priority level of communication by the application.

For example, the generation unit 3 specifies, out of the aforementioned types of device information, one or more types of device information that are necessary to generate setting information for the new network.

The generation unit 3 transmits an information request notification to the existing functional units, the new functional unit, and the relay device 101B, the information request notification indicating that the specified type(s) of device information should be transmitted.

The existing functional units, the new functional unit, and the relay device 101B then transmit to the generation unit 3, as a response to the information request notification received from the generation unit 3, their own device information of the type(s) designated in the information request notification, for example.

Furthermore, the generation unit 3 refers to the storage unit 6 to acquire the specified type(s) of device information on the relay device 101A from the storage unit 6.

The generation unit 3 generates setting information for the new network based on the acquired device information.

More specifically, the generation unit 3 generates setting information indicating setting contents for the relay devices 101A and 101B for enabling communication in the new network.

For example, based on the acquired device information, the generation unit 3 generates setting information indicating setting contents for the relay devices 101 for enabling the functional units and the relay devices 101A and 101B to perform communication in the new network, such as the filtering in the relay devices 101A and 101B, the communication bandwidth, and the VLAN settings.

Based on the generated setting information, the generation unit 3 notifies at least one of the relay devices 101A and 101B of the setting contents for enabling communication in the new network.

For example, based on the setting information, the generation unit 3 notifies a relay device 101 whose settings need to be changed of the setting contents. If there is no relay device 101 whose settings need to be changed in the new network, the generation unit 3 does not notify the setting contents, for example. The generation unit 3 also outputs updated device information indicating the device that is notified of the setting contents, to the update confirmation unit 2.

To notify the relay device 101A of the setting contents, the generation unit 3 notifies the setting unit 4 of the setting contents. To notify the relay device 101B of the setting contents, the generation unit 3 transmits the setting information indicating the setting contents to the relay device 101B via the relay unit 1.

Upon being notified of the setting contents by the generation unit 3, the setting unit 4 of the relay device 101A and the setting unit 14 of the relay device 101B perform various setting changes in accordance with the notified setting contents.

Note that the generation unit 3 may be configured to generate setting information that further indicates setting contents for the existing functional units and the new functional unit and notifies, based on the setting information, the functional units, in addition to the relay devices 101, of the setting contents for enabling communication in the new network.

The functional units and the relay devices 101A and 101B in the new network communicate with each other in accordance with the changed setting contents.

### Problems

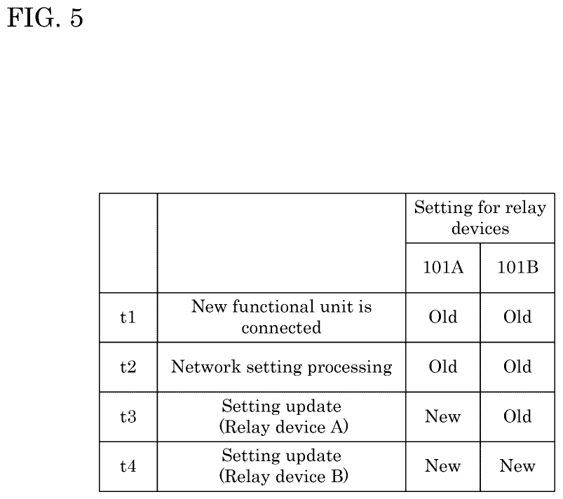

FIG. 5 shows an example of setting statuses of the relay devices in the in-vehicle communication system according to the embodiment of the present disclosure.

Referring to FIG. 5, first, a new functional unit is connected to the in-vehicle network 401. At this point in time, the settings for the relay devices 101A and 101B are old settings, that is, the setting contents for the existing network (timing t1).

Next, the relay device 101A starts network setting processing such as the collection of device information and the generation of setting information for a new network. At this point in time, the settings for the relay devices 101A and 101B remain the old settings (timing t2).

Next, in the relay device 101A, setting contents are changed based on the setting information so as to enable communication in the new network. At this point in time, since this is internal processing, the settings for the relay device 101A are updated to new settings, that is, the setting contents for the new network, while the settings for the relay device 101B still remain the old settings due to delays in communication processing and the like (timing t3).

Next, in the relay device 101B that has received the setting information from the relay device 101A, setting contents are changed based on the setting information so as to enable communication in the new network. As a result, the settings for both the relay devices 101A and 101B have been changed to the new settings (timing t4).

Here, if the new functional unit transmits a frame addressed to another functional unit at any of the timings t1 to t3, or in other words, while some of the setting changes for the new network have not yet been completed, that frame increases the amount of traffic in the in-vehicle network 401, which may affect the existing communication between functional units. For example, a decrease in transmission quality, such as delays of frames between existing functional units, may occur, or a frame may be discarded due to stagnation of frames in the relay devices 101.

To address such problems, the in-vehicle communication system according to the embodiment of the present disclosure is configured as described below.

In the relay device 101B, the control unit 15 restricts relay processing of frames transmitted from a new functional unit, which is a functional unit detected by the detection unit 12, except for a frame used for setting processing for enabling communication in the new network, which is the in-vehicle network 401 including the new functional unit. Then, when the setting processing is completed, the control unit 15 relaxes the restriction on the relay processing.

For example, when the setting processing of all the relay devices 101 in the in-vehicle network 401 is completed, the control unit 15 relaxes the restriction on the relay processing.

Alternatively, for example, the control unit 15 restricts relay processing of frames transmitted from the new functional unit except for a frame used for authentication processing for the new functional unit. Then, when the authentication processing is completed, the control unit 15 restricts relay processing of frames transmitted from the new functional unit except for a frame used for the above-described setting processing.

This means that the control unit 15 performs filtering settings divided into two stages: communication necessary for device authentication and communication necessary for performing setting changes for the new network.

For example, the control unit 15 changes the value of a configuration register of the relay unit 11, thereby setting the content of the relay processing performed by the relay unit 11. As an example, the relay unit 11 performs filtering according to IEEE 802.1Qci. The relay unit 11, according to the settings set by the control unit 15, permits the relaying of a received frame or discards the frame, depending on the MAC address, VLAN ID, IP address, Differentiated Services Code Point (DSCP) value, protocol, port number, and the like contained in the frame.

More specifically, in an initial state, the control unit 15 sets the relay unit 11 so that it permits the relaying of a frame containing connection request information and discards frames from an idle port, that is, a communication port 51 to which no other devices are connected, except for the frame containing connection request information.

Upon receiving a notification from the detection unit 12 to the effect that a new functional unit has been detected as described above, the control unit 15 changes the settings for the relay unit 11 with respect to a communication port 51 that has changed from an idle port to a connected port, or in other words, a communication port 51 to which the new functional unit is connected. Specifically, the control unit 15 permits the relay unit 11 to relay a frame for authentication processing received from the communication port 51 to which the new functional unit is connected, and maintains the setting to discard frames other than this frame.

The relay unit 11 outputs, to the authentication unit 13, the frame for authentication processing received from the connected port. The authentication unit 13 performs the above-described authentication processing and then notifies the control unit 15 to the effect that the new functional unit has been successfully authenticated.

Upon receiving the notification from the authentication unit 13 to the effect that the new functional unit has been successfully authenticated, the control unit 15 changes the settings for the relay unit 11 with respect to the connected port. Specifically, the control unit 15 permits the relay unit 11 to relay a frame for network setting processing received from the communication port 51 to which the new functional unit is connected, and maintains the setting to discard frames other than this frame.

Furthermore, for example, when the setting processing of the relay device 101B using the frame for network setting processing is completed, the setting unit 14 issues a predetermined notification to the other devices in the in-vehicle network 401.

Specifically, the setting unit 14 transmits, to the update confirmation unit 2 of the relay device 101A via the relay unit 11, an update completion notification indicating that various setting changes according to the setting contents notified from the generation unit 3 are completed.

In the relay device 101A, the update confirmation unit 2 confirms that the setting processing for enabling communication in the new network, which is the in-vehicle network 401 in which the new functional unit is connected to the relay device 101B, has been completed in the plurality of relay devices, in this case the relay devices 101A and 101B.

If the update confirmation unit 2 confirms the completion, the notification unit 5 notifies the relay device 101B to which the new functional unit is connected of this completion.

Specifically, the setting unit 4 outputs, to the update confirmation unit 2, an update completion notification indicating that various setting changes according to the setting contents notified from the generation unit 3 have been completed.

If the update confirmation unit 2 receives update completion notifications from all the devices, for example, the relay devices 101A and 101B, designated by the updated device information received from the generation unit 3, the update confirmation unit 2 determines that network setting processing, that is, setting processing for enabling communication in the new network has been completed, and notifies the notification unit 5 to the effect that the setting processing has been completed.

The notification unit 5 then transmits, to the relay device 101B via the relay unit 1, a frame permission notification indicating that the network setting processing has been completed and frame transmission from the new functional unit is permitted.

In the relay device 101B, the control unit 15 receives the frame permission notification from the relay device 101A via the relay unit 11 and changes the settings for the relay unit 11 with respect to the connected port. Specifically, the control unit 15 removes the setting to discard frames from the communication port 51 to which the new functional unit is connected, and permits the relay unit 11 to relay all the frames from this communication port 51. Note that the control unit 15 may be configured to maintain the setting to prohibit the relaying of frames from this communication port 51 to a specific in-vehicle ECU 202, according to the setting contents for the new network generated by the generation unit 3, for example.

### Operation Flow

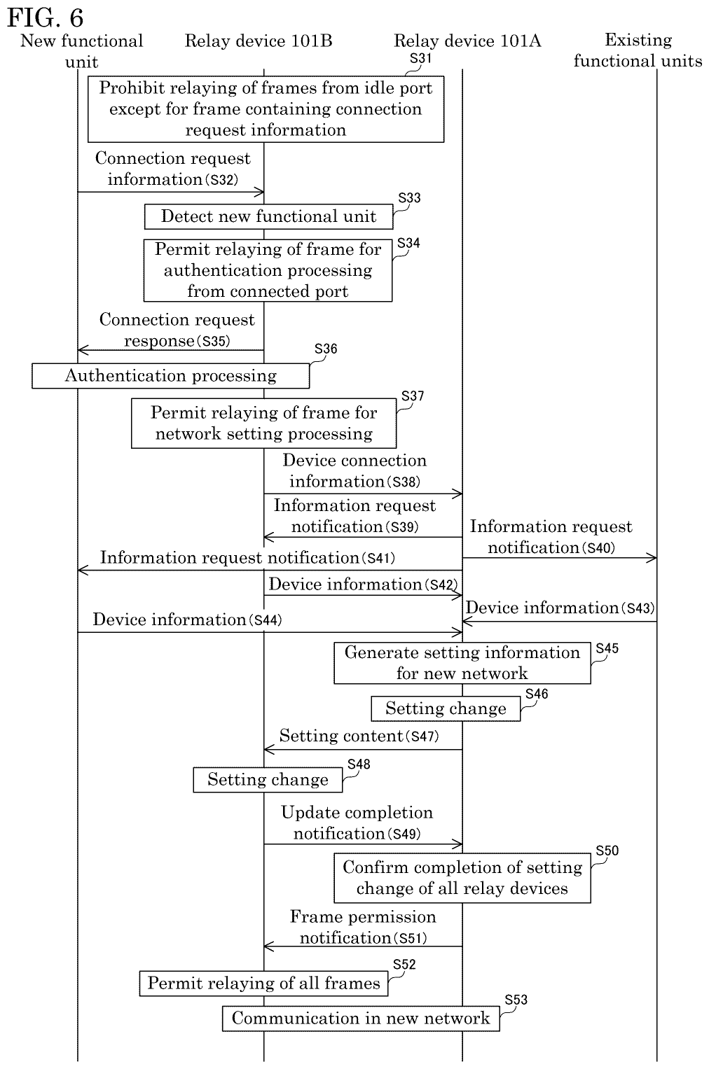

FIG. 6 is a diagram showing an example of the sequence of processing for constructing a new network that is performed in the in-vehicle communication system according to the embodiment of the present disclosure.

Referring to FIG. 6, first, the relay unit 11 of the relay device 101B is set to prohibit the relaying of frames received at an idle port except for a frame containing connection request information and discard such frames (step S31).

Next, a new functional unit is connected to an idle port of the relay device 101B. The new functional unit transmits connection request information to the relay device 101B (step S32).

Next, the relay device 101B receives the connection request information and detects the new functional unit (step S33), and permits the relaying of a frame for authentication processing received at the connected port (step S34).

Next, the relay device 101B transmits a connection request response to the new functional unit (step S35), and various information is transmitted and received between the relay device 101B and the new functional unit to perform authentication processing for the new functional unit (step S36).

Next, if the new functional unit is successfully authenticated, the relay device 101B permits the relaying of a frame for network setting processing received at the connected port (step S37), and transmits device connection information to the relay device 101A (step S38).

Next, the relay device 101A transmits information request notifications for requesting device information to the relay device 101B, the new functional unit, and existing functional units (steps S39 to S41).

Next, the relay device 101B, the new functional unit, and the existing functional units transmit, to the relay device 101A, their own device information of a type designated in the information request notifications, as responses to the information request notifications (steps S42 to S44).

Next, the relay device 101A generates setting information for a new network based on the device information received from the relay device 101B, the new functional unit, and the existing functional units as well as the device information of the relay device 101A (step S45).

Next, the relay device 101A changes various settings for the relay device 101A itself based on the generated setting information (step S46), and notifies the relay device 101B of the setting contents (step S47).

Next, the relay device 101B changes various settings according to the setting contents notified from the relay device 101A (step S48).

Next, the relay device 101B transmits an update completion notification to the relay device 101A (step S49).

Next, due to receiving an update completion notification from the setting unit 4 of the relay device 101A and the update completion notification from the relay device 101B, the relay device 101A confirms that the setting changes of all the relay devices have been completed (step S50), and then transmits a frame permission notification to the relay device 101B (step S51).

Next, the relay device 101B permits the relaying of all frames from the communication port 51 to which the new functional unit is connected (step S52).

Next, the relay devices 101A and 101B, the new functional unit, and the existing functional units in the new network communicate with each other according to the changed setting contents (step S53).

Here, the difference in the timing of completion of the setting processing between the relay devices 101 tends to increase as the number of relay devices 101 provided in the in-vehicle network 401 increases. Accordingly, the effect achieved by permitting the relaying of frames transmitted by the new functional unit after the completion of the network setting processing as described above is increased.

Note that the network setting processing performed by the generation unit 3, the setting units 4 and 14, and the like may include setting the priority levels of frames to be transmitted from the functional units in the new network.

Thus, even when the new functional unit is an in-vehicle ECU that transmits information with a large data volume, such as video, network setting processing for assigning a lower priority level to such information and assigning a higher priority level to information related to travel control of the vehicle 501 can be completed before permitting frames transmitted from the new functional unit to be transmitted in the in-vehicle network 401, and this can more reliably prevent the travel of the vehicle 501 from being affected.

The in-vehicle communication system 301 may alternatively be configured not to perform the above-described authentication processing for a new functional unit.

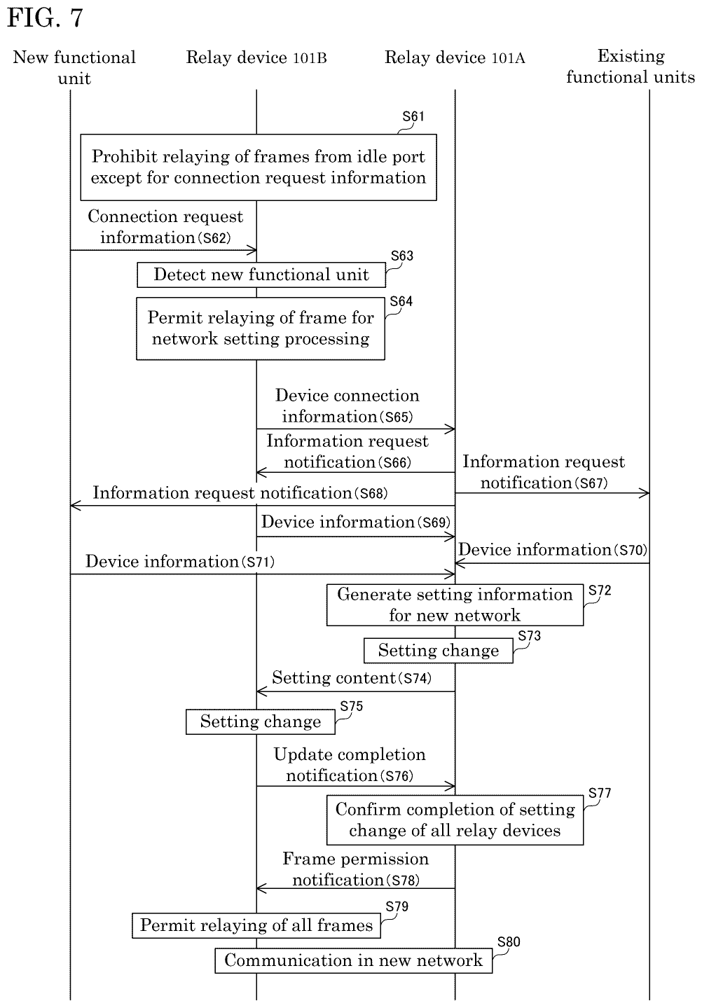

FIG. 7 is a diagram showing another example of the sequence of processing for constructing a new network that is performed in the in-vehicle communication system according to the embodiment of the present disclosure.

Referring to FIG. 7, first, the relay unit 11 of the relay device 101B is set to prohibit the relaying of frames received at an idle port except for a frame containing connection request information and discard such frames (step S61).

Next, a new functional unit is connected to an idle port of the relay device 101B. The new functional unit transmits connection request information to the relay device 101B (step S62).

Next, the relay device 101B receives the connection request information and detects the new functional unit (step S63), permits the relaying of a frame for network setting processing received at the connected port (step S64), and transmits device connection information to the relay device 101A (step S65).

Processing in steps S66 to S80 is the same as that of steps S39 to S53 shown in FIG. 6.

Note that although the in-vehicle communication system according to the embodiment of the present disclosure has been described as being configured such that the relay device 101A functions as a monitoring device, the present disclosure is not limited to this. The in-vehicle communication system 301 may be configured to include a device that includes the update confirmation unit 2 and the notification unit 5, separately from the relay device 101A.

Alternatively, the relay device 101A may be configured to further include the detection unit 12, the authentication unit 13, and the control unit 15 and execute similar processing to that of the relay device 101B when a new functional unit is connected. In this case, the in-vehicle communication system 301 may be configured to include one relay device 101A and no relay device 101B.

Furthermore, a configuration may be adopted in which the relay device 101B does not include the authentication unit 13, and a server or the like outside the vehicle 501 executes authentication processing for a new functional unit.

Furthermore, although the in-vehicle communication system according to the embodiment of the present disclosure has been described as being configured such that the setting unit 14 of the relay device 101B issues a predetermined notification to the relay device 101A, which is another device in the in-vehicle network 401, when the setting processing of the relay device 101B using a frame for network setting processing is completed, the present disclosure is not limited to this. The setting unit 14 may be configured not to issue the predetermined notification above. In this case, for example, the relay device 101A transmits a frame permission notification indicating permission of frame transmission from the new functional unit to the relay device 101B after a predetermined period of time has elapsed from when the relay device 101A notified the relay device 101B of the setting contents for enabling communication in the new network.

Each of the processes (functions) in the aforementioned embodiments is implemented by a processing circuit including one or more processors. The processing circuit may be configured by an integrated circuit or the like in which one or more memories, various analog circuits, and various digital circuits are combined in addition to the one or more processors. The one or more memories store programs (instructions) for causing the one or more processors to execute the respective processes. The one or more processors may execute the respective processes according to the programs read from the one or more memories, or may execute the respective processes according to logic circuits designed in advance to execute the respective processes. The processors may be various types of processors suitable for controlling a computer, such as a Central Processing Unit (CPU), Graphics Processing Unit (GPU), Digital Signal Processor (DSP), Field Programmable Gate Array (FPGA), and Application Specific Integrated Circuit (ASIC). Note that a plurality of physically separated processors may cooperate with each other to execute the respective processes. For example, the processors mounted on a plurality of physically separated computers may cooperate with each other to execute the respective processes via a network such as a Local Area Network (LAN), Wide Area Network (WAN), or the Internet. The program may be installed in the memory via the network from an external server device or the like, or may be distributed while being stored in a recording medium such as a Compact Disc Read Only Memory (CD-ROM), Digital Versatile Disc Read Only Memory (DVD-ROM), or semiconductor memory, and may be installed in the memory from the recording medium.

The foregoing embodiments are to be construed in all respects as illustrative

and not restrictive. The scope of the present invention is defined by the claims rather than the description above, and is intended to include all modifications within the meaning and scope of the claims and equivalents thereof.

The above description includes the features that are supplementarily noted below.

### Supplementary Note 1

A relay device for use in an in-vehicle network that includes a plurality of functional units, the relay device including:
a relay unit configured to perform relay processing for relaying frames transmitted and received between the functional units;
a detection unit configured to detect addition of a functional unit to the in-vehicle network; and
a control unit configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed,
the control unit being configured to permit the relaying of all frames transmitted from the new functional unit when the setting processing is completed, and
the setting processing including setting priority levels of frames to be transmitted from the functional units in the new network.

### Supplementary Note 2

A monitoring device for use in an in-vehicle network that includes a plurality of functional units and a plurality of relay devices configured to relay frames transmitted and received between the functional units, the monitoring device including:
an update confirmation unit configured to confirm completion of setting processing of the plurality of relay devices, the setting processing being for enabling communication in a new network, which is the in-vehicle network in which a new functional unit is connected to any of the relay devices; and
a notification unit configured to, if the update confirmation unit confirms the completion, notify the relay device to which the new functional unit is connected of the completion,
the setting processing including setting priority levels of frames to be transmitted from the functional units in the new network.

### Supplementary Note 3

A relay device for use in an in-vehicle network that includes a plurality of functional units, the relay device including:
a processing circuit,
the processing circuit being configured to
   perform relay processing for relaying frames transmitted and received between the functional units;
   detect addition of a functional unit to the in-vehicle network and restrict the relay processing of frames transmitted from the new functional unit, which is the detected functional unit, except for a frame used for setting processing for enabling communication in a new network, which is the in-vehicle network further including the new functional unit; and
   relax the restriction on the relay processing when the setting processing is completed.

### Supplementary Note 4

A monitoring device for use in an in-vehicle network that includes a plurality of functional units and a plurality of relay devices configured to relay frames transmitted and received between the functional units, the monitoring device including:
a processing circuit,
the processing circuit being configured to
   confirm completion of setting processing of the plurality of relay devices, the setting processing being for enabling communication in a new network, which is the in-vehicle network in which a new functional unit is connected to any of the relay devices; and
   notify, if the completion is confirmed, the relay device to which the new functional unit is connected of the completion.

### Supplementary Note 5

A relay method of a relay device for use in an in-vehicle network that includes a plurality of functional units, the relay device being configured to perform relay processing for relaying frames transmitted and received between the functional units, the relay method including:
a step of detecting addition of a functional unit to the in-vehicle network;
a step of restricting the relay processing of frames transmitted from a new functional unit, which is the detected functional unit, except for a frame used for setting processing for enabling communication in a new network, which is the in-vehicle network further including the new functional unit; and
a step of relaxing the restriction on the relay processing when the setting processing is completed.

### Supplementary Note 6

A monitoring method of a monitoring device for use in an in-vehicle network that includes a plurality of functional units and a plurality of relay devices configured to relay frames transmitted and received between the functional units, the monitoring method including:
a step of confirming completion of setting processing of the plurality of relay devices, the setting processing being for enabling communication in a new network, which is the in-vehicle network in which a new functional unit is connected to any of the relay devices; and
a step of notifying, if the completion is confirmed, the relay device to which the new functional unit is connected of the completion.

### DESCRIPTIONS OF REFERENCE NUMERALS

1 relay unit
2 update confirmation unit
3 generation unit
4 setting unit
5 notification unit
6 storage unit
11 relay unit
12 detection unit
13 authentication unit
14 setting unit
15 control unit
16 storage unit
51 communication port
101,101A,101B relay device
202,202A,202B,202C in-vehicle ECU
301 in-vehicle communication system
401 in-vehicle network
501 vehicle

1. A relay device for use in an in-vehicle network that includes a plurality of functional units, the relay device comprising:
a relay unit including a circuitry configured to perform relay processing for relaying frames transmitted and received between the functional units;
a detection unit including a circuitry configured to detect addition of a functional unit to the in-vehicle network; and
a control unit including a circuitry configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed.

2. The relay device according to claim 1,
wherein the in-vehicle network includes, in addition to a first relay device, which is the relay device, one or more second relay devices, which are relay devices configured to relay frames transmitted and received between the functional units, and
the control unit is configured to relax the restriction on the relay processing when the setting processing of all the relay devices in the in-vehicle network is completed.

3. The relay device according to claim 2,
wherein the first relay device further includes:
a setting unit including a circuitry configured to issue a predetermined notification to the other devices in the in-vehicle network when the setting processing of the first relay device is completed.

4. The relay device according to claim 1,
wherein authentication processing for the new functional unit is performed prior to the setting processing, and
the control unit is configured to restrict the relay processing of frames transmitted from the new functional unit except for a frame used for the authentication processing for the new functional unit and to restrict the relay processing of frames transmitted from the new functional unit except for a frame used for the setting processing when the authentication processing is completed.

5. A monitoring device for use in an in-vehicle network that includes a plurality of functional units and a plurality of relay devices configured to relay frames transmitted and received between the functional units, the monitoring device comprising:
an update confirmation unit including a circuitry configured to confirm completion of setting processing of the plurality of relay devices, the setting processing being for enabling communication in a new network, which is the in-vehicle network in which a new functional unit is connected to any of the relay devices; and
a notification unit including a circuitry configured to, if the update confirmation unit confirms the completion, notify the relay device to which the new functional unit is connected of the completion.

6. The monitoring device according to claim 5, further comprising:
a generation unit including a circuitry configured to create a setting content for enabling communication in the new network and notify one or more of the relay devices of the setting content.

7. A non-transitory computer readable medium storing a relay program for a relay device for use in an in-vehicle network that includes a plurality of functional units, the relay program causing a computer to function as:
a relay unit configured to perform relay processing for relaying frames transmitted and received between the functional units;
a detection unit configured to detect addition of a functional unit to the in-vehicle network; and
a control unit configured to restrict the relay processing of frames transmitted from a new functional unit, which is the functional unit detected by the detection unit, except for a frame used for setting processing for enabling communication in a new network, which is the in-vehicle network further including the new functional unit, and to relax the restriction on the relay processing when the setting processing is completed.

8. A non-transitory computer readable medium storing a monitoring program for a monitoring device for use in an in-vehicle network that includes a plurality of functional units and a plurality of relay devices configured to relay frames transmitted and received between the functional units, the monitoring program causing a computer to function as:
an update confirmation unit configured to confirm completion of setting processing of the plurality of relay devices, the setting processing being for enabling communication in a new network, which is the in-vehicle network in which a new functional unit is connected to any of the relay devices; and
a notification unit configured to, if the update confirmation unit confirms the completion, notify the relay device to which the new functional unit is connected of the completion.

9. The relay device according to claim 2,
wherein authentication processing for the new functional unit is performed prior to the setting processing, and
the control unit is configured to restrict the relay processing of frames transmitted from the new functional unit except for a frame used for the authentication processing for the new functional unit and to restrict the relay processing of frames transmitted from the new functional unit except for a frame used for the setting processing when the authentication processing is completed.

10. The relay device according to claim 3,
wherein authentication processing for the new functional unit is performed prior to the setting processing, and
the control unit is configured to restrict the relay processing of frames transmitted from the new functional unit except for a frame used for the authentication processing for the new functional unit and to restrict the relay processing of frames transmitted from the new functional unit except for a frame used for the setting processing when the authentication processing is completed.
